(19) United States
(12) Patent Application Publication
(10) Pub. No.: US 2015/0332612 A1
(43) Pub. Date: Nov. 19, 2015

(54) Label And Laminate Having Selectively Applied Adhesive

(71) Applicants: Brad Lee Shuff, Morristown, TN (US); Timothy Darren Livingston, Corryton, TN (US)

(72) Inventors: Brad Lee Shuff, Morristown, TN (US); Timothy Darren Livingston, Corryton, TN (US)

(21) Appl. No.: 14/559,613

(22) Filed: Dec. 3, 2014

Related U.S. Application Data
(60) Provisional application No. 61/996,700, filed on May 14, 2014.

(51) Int. Cl. G09F 3/02; G09F 3/10; B32B 37/12

(52) U.S. Cl. CPC G09F 3/02; B32B 37/12; G09F 3/10; G09F 2003/0241; G09F 2003/0248; G09F 2003/0257

(57) ABSTRACT

Disclosed herein is a laminate and method of making the same, the laminate including a face layer and a liner layer. A plurality of release coating sections are applied to the liner and the face layer and at least two of the plurality of release coating sections are located on the face layer and are spaced apart at a distance from each other to define a gap. Another one of the release coating sections aligns with the gap. A section of adhesive aligns with the gap and is disposed between the face layer and one of the release coating sections. A pair of cut lines extend into the face layer and are spaced apart at a distance such the section of adhesive and one of the plurality of release coating sections applied to the face layer are disposed between the pair of cut lines.

### FIELD OF THE INVENTION

The present invention relates to a laminate for making adhesive labels and particular to a partially-secured shelf label and method of manufacturing the same.

### BACKGROUND OF THE INVENTION

Labels have been used in retail businesses for displaying product information and/or pricing to consumers. Many retail displays allow consumers to select the product and quantity they would like to purchase, and labels can be affixed to the display shelves to allow consumers to know pricing and other information relating to the product to be purchased. In some cases, products are moved, prices change or other information needs to be updated, and labels will be removed and a new label applied. In addition, the shelf will often have a finite thickness that provides limited space. Thus, some labels have been designed to secure partially to the shelf and include an area of deactivated or deadened adhesive that may hang down below the shelf. For example, such labels are shown in U.S. Pat. Nos. 6,579,585, and 6,926,942. Other examples of labels are shown in U.S. Pat. No. 8,261,477. All of these labels include a layer of adhesive over substantially the entire rear surface of the label and a deadening or deactivating agent applied selectively over such adhesive to create a label sheet that includes an active adhesive at a top (or side) edge and an inactive (deadened) adhesive at a bottom (or opposite side) edge.

Use of a deadening/deactivating agent provides a number of difficulties when manufacturing the label sheet and labels. Typically, a laminate will begin as an adhesive laminate containing no deadening agent. This laminate will be separated so that the face layer is pulled away from the liner such that the face layer and adhesive are on one side and the release/liner are on another side. The deadening agent is then applied either to the adhesive or to the release side and the two sections are re-laminated. Thus, in some cases, the use of a deadener requires a step of de-laminating an already made laminate to modify the properties thereof. Although other processes may be contemplated for manufacture of the labels having a deactivated or deadened adhesive section, these processes still require the use of an adhesive deactivating material, thus adding a material expense to the process.

This process is inefficient either due to the de-lamination and re-lamination processes, the use of a deactivating agent or both. Thus it is desirable to eliminate the need for an adhesive deadener or deactivating agent while still providing for an adhesive section and a non-adhesive section on the label.

### SUMMARY OF THE INVENTION

Therefore it is an object of the invention to provide a laminate that allows adhesive to be selectively located on a label.

It is yet another object of the invention to provide a laminate for creating a shelf marking label that avoids the use of a deadening or deactivating agent.

It is yet a further object of the invention to provide a laminate that uses selectively applied release coatings to provide adhesive properties in sections of a label where such adhesive properties are desirable.

Yet further objects are to provide a label from the aforementioned laminate such that multiple discreet labels can be printed and then removed from the liner so that part of the label has adhesive thereon, and another part of the label does not include adhesive.

Still another object is to provide a laminate sheet that can be cut in to multiple discreet labels in a way that the non-adhesive section of the label will remain adhered to the liner during printing so as not to clog or damage the printer with adhesive.

These and other objects are achieved by providing a laminate including a face layer and a liner layer and a plurality of release coating sections. The release coating sections are selectively applied to the liner and the face layer, such that an adhesive layer disposed between the liner and face layers adheres to either the liner or the face layer in a section between the sections of release coatings when the face layer is removed from the liner layer.

In some aspects, a laminate includes a face layer and a liner layer. A plurality of release coating sections are selectively applied to the liner and the face layer, such that an adhesive layer disposed between the liner and face layers adheres to either the liner or the face layer in a section between the sections of release coatings when the face layer is removed from the liner layer. In other aspects, the laminate includes cuts in the face layer that terminate at the liner layer such that the cuts define a plurality of individual labels. In other aspects, the cuts are disposed such that each label includes a section of adhesive and a section of release coating, wherein part of the adhesive layer adheres to the face layer at the adhesive section and the adhesive section is disposed between two sections of release coating, one of the two sections of release coating is disposed on the label of the adhesive section, the other of the two sections of the release coating is disposed on an adjacent label.

In other aspects a label sheet includes a face layer and a liner layer. A first release coating section is applied to part of the face layer and is adjacent to an edge of the face layer. A second release coating section is applied to part of the liner layer and is adjacent to an opposite edge of the face layer. Adhesive is applied between the face layer and the liner layer such a first section of the adhesive adheres to the liner layer and a second section of the adhesive adheres to the face layer when the face and liner layers are separated.

In another aspect, a method of manufacturing a label is provided and includes one or more of the steps of (in no particular order): providing a face layer; providing a liner layer; applying a first release coating section to part of the face layer; applying a second release coating section to the liner layer; and laminating the face and liner layers by applying adhesive between the face and liner layers.

In some aspects, the method can include cutting the face layer to define a label such that when the label is removed from the liner layer, a section of adhesive is adjacent to a first edge of the label and a section of release coating is adjacent to an opposite edge of the label. In one aspect, the cutting step defines a cut extending through the face layer and terminating at the liner layer.

Other objects are achieved by providing a laminate including a face layer and a liner layer. An adhesive is disposed between the face and liner layers. A first section of release coating is applied to the face layer between the face layer and the adhesive and has a first width. A second section of release coating is applied to the liner layer parallel to the first section and disposed between the liner layer and the adhesive, the second section of release coating has a second width. A cut line extends into the face layer along an edge of the first section of release coating.

In some aspects part of the first and second sections of release coating extend along opposite sides of the cut line. In other aspects a common plane is defined by an edge of the first section of release coating and an edge of said second section of release coating and the cut line extends along the common plane. In other aspects the cut line includes a pair of cut lines spaced apart at a distance such that the first and second sections of release coating are located between the pair of cut lines.

In some aspects the adhesive includes a plurality of adhesive sections and the laminate includes a width of at least one of the plurality of adhesive sections being less than one of the first or second widths to define a void between the face and liner layers. The cut line extends through the face layer at the void. In other aspects the adhesive includes a plurality of adhesive sections and the laminate includes a first one of the plurality of adhesive sections disposed parallel to the first section of release coating and disposed between the second section of release coating and the face layer. A second one of the plurality of adhesive sections may be disposed parallel to the second section of release coating and disposed between the first section of release coating and the liner layer.

In yet other aspects the adhesive includes a plurality of adhesive sections and laminate includes a width of at least one of the plurality of adhesive sections being less than one of the first or second widths to define a void between the face and liner layers. In one aspect, the cut line may extend into the face layer at the void. In yet another aspect the cut line includes a pair of cut lines spaced apart at a distance such that the first and second sections of release coating are located between the pair of cut lines and two cut lines are spaced apart and extend between the pair of cut lines such that the two cut lines and the pair of cut lines define a perimeter of a label.

Other objects are achieved by providing a laminate including a face layer and a liner layer. A plurality of release coating sections are applied to the liner and the face layer such that at least two of the plurality of release coating sections are located on the face layer. The at least two of the plurality of release coating sections are spaced apart at a distance from each other to define a gap. Another one of said plurality of release coating sections is aligned with the gap. A section of adhesive is aligned with the gap and disposed between the face layer and the at least one of the plurality of release coating sections. A pair of cut lines extend into the face layer and are spaced apart at a distance such the section of adhesive and one of the plurality of release coating sections applied to the face layer are disposed between the pair of cut lines.

In one aspect a width of the section of adhesive is less than a width of said gap and a void is formed between adhesive and release sections. The cut line may extend through the face layer at the void. In other aspects one of the at least two of the plurality of release coating sections and the another one of the plurality of release coating sections each have an edge defining a plane, the one of the at least two of said plurality of release coating sections and the another one of the plurality of release coating sections extend in opposite directions from the plane.

In other aspects two cut lines are disposed at an angle relative to the pair of cut lines wherein the pair of cut lines intersect with the two cut lines to define a perimeter of a label. In other aspects the laminate includes printed indicia on an outer surface of the face layer. In some aspects the adhesive is a pressure sensitive adhesive. In other aspects the release coating comprises silicone.

Other objects are achieved by providing a method of manufacturing a laminate including one or more of the steps of: providing a face layer; providing a liner layer; applying a plurality of strips of release coating to the face and liner layers; applying a plurality of strips of adhesive to the face and liner layers; laminating the face and liner layers such that at least one adhesive strip of the face layer aligns with at least one of said plurality of strips of release coating applied to the liner layer; and cutting the face layer to define a pair of cut lines spaced apart such that the section of adhesive and one of the plurality of release coating sections applied to the face layer are disposed between the pair of cut lines.

In some aspects each one of the strips of adhesive of the face layer aligns with one of the strips of release coating. In other aspects a width of the strips of adhesive of the face layer is less than a width of the aligned strip of release coating of the liner layer such that a void is formed between the strips of adhesive of the face layer and the strips of release coating of the face layer. In other aspects the step of applying a plurality of release coatings defines at least one adhesive receiving section between two of said plurality of strips of release coating, at least one of the plurality of strips of adhesive applied to the at least one adhesive receiving section; and the cutting step further comprises cutting through the face layer at an angle relative to the pair of cut lines to define two of cut lines, the two cut lines extending between the pair of cut lines such that the pair of cut lines and the two cut lines define a perimeter of a label. In still other aspects the method may include cutting the face layer to define a label such that when the label is removed from the liner layer, a section of adhesive is adjacent to a first edge of the label and a section of release coating is adjacent to an opposite edge of the label. In yet other aspects the cutting step defines a cut extending through said face layer and terminating at the liner layer.

Other objects of the invention and its particular features and advantages will become more apparent from consideration of the following drawings, claims and accompanying detailed description. It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions or combinations of functions described herein.

### BRIEF DESCRIPTION OF THE DRAWINGS

FIG. 1 is a partially exploded side view of a laminate for making individual labels according to the present invention.

FIG. 2 is an assembled view of the laminate of FIG. 1.

FIG. 3 shows the rear side of the face layer of FIG. 1 where the liner has been removed.

FIG. 4 is a perspective view of a label of FIG. 1 applied to a shelf.

FIG. 5 is a perspective view of a label of FIG. 1.

FIG. 6 is a side view of a label of FIG. 1 removed from the laminate.

FIG. 7 is an alternate configuration of the laminate and shows rear side view of the face layer of FIG. 1 where the liner has been removed.

FIG. 8 is still another alternate configuration of the laminate and shows rear side view of the face layer of FIG. 1 where the liner has been removed.

FIG. 9 is another partially exploded side view of a laminate for making labels according to the present invention.

FIG. 10 is an assembled view of the laminate of FIG. 9.

FIG. 11 shows the rear side of the face layer of FIG. 9 where the liner has been removed.

FIG. 12 is a top view of the laminate of FIG. 1 formed into a sheet of labels.

FIG. 13 is a top view of the laminate of FIG. 1 formed into a sheet of labels having a different orientation than the sheet shown in FIG. 12.

FIG. 14 is a partially exploded side view of a laminate similar to FIG. 1 for making individual labels according to the present invention.

FIG. 15 is an assembled view of the laminate of FIG. 14.

FIG. 16 is a partially exploded side view of a laminate similar to FIG. 1 for making individual labels according to the present invention.

FIG. 17 is an assembled view of the laminate of FIG. 16.

FIG. 18 is a schematic view of the machinery and method used in making the laminate and labels shown in FIGS. 1-17.

### DETAILED DESCRIPTION OF THE INVENTION

Referring now to the drawings, wherein like reference numerals designate corresponding structure throughout the views, the following examples are presented to further illustrate and explain the present invention and should not be taken as limiting in any regard.

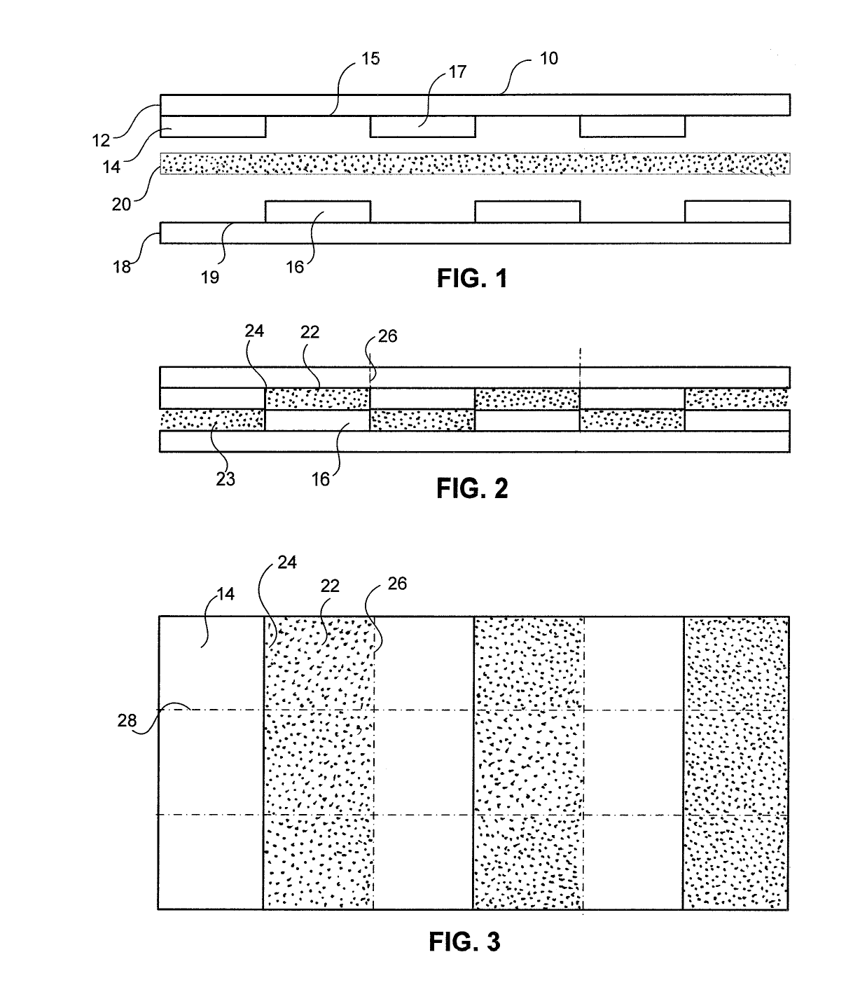

In FIGS. 1-3, the outer surface 10 of face layer 12 can have graphics printed thereon, for example product information, pricing or other information that may be communicated to a customer in a retail environment. Release coating sections 14/16 are selectively applied either to the liner 18 or the face layer 12, for example, in alternating fashion. Section 14 is applied to the face layer and section 16 is applied to the liner. Thus, when the liner and face layer are assembled, adhesive 20 will only adhere to the sections adjacent to the release coatings. Adhesive 20 will adhere to non-release section 15 so that when the a label defined by cut lines 26/28 is removed from the liner, adhesive section 22 adheres to the non-release section 15 and adhesive section 23 adheres to the liner 18 at non-release section 19. Thus the label will include a release section 14 and an adhesive section 22 on the rear surface thereof so that when the label is adhered to a retail shelf, the adhesive section 22 will adhere to the shelf and the release section will not adhere to other items in the vicinity thereof, for example, a customer's fingers or other products on nearby shelves.

As shown in FIG. 3, edge 24 defines where the release coating ends and adhesive 22 begins. In addition, cut line 26 also defines an edge of the release coating for the adjacent release section 17.

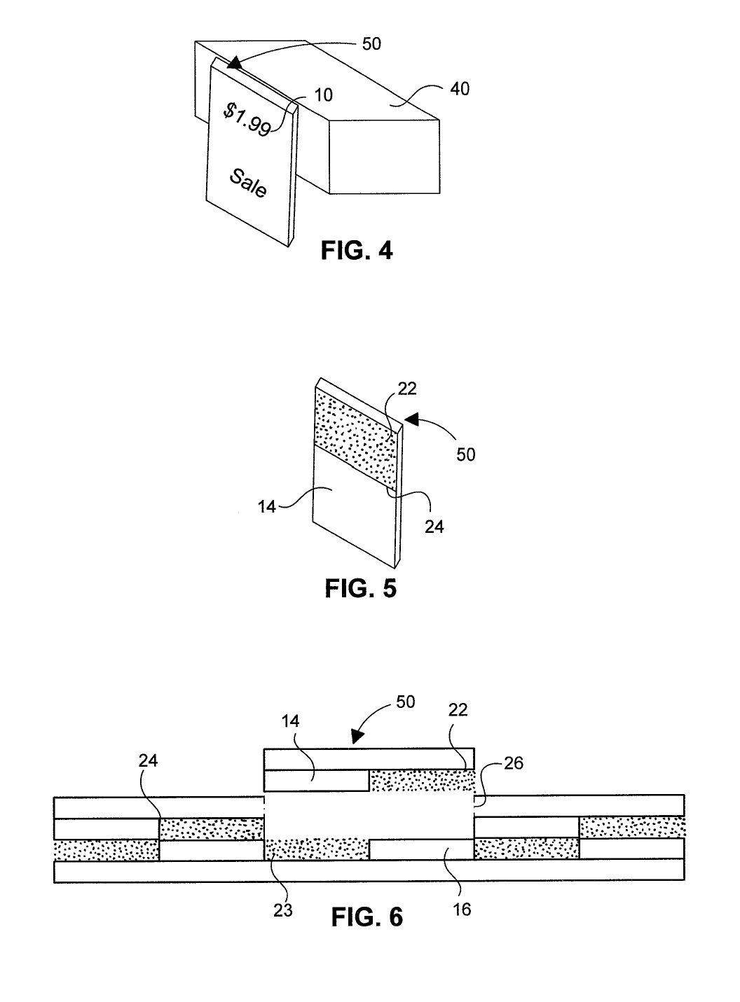

In FIG. 4, label 50 is shown applied to a shelf 40, for example, in a retail display environment. Graphics 10, such as price or other information, is therefore displayed to consumers. As shown in FIG. 5, the rear side of the label 50 includes adhesive 22 and release 14 sections. As can be seen by FIG. 6, label 50 is removed from the laminate and adhesive section 23 adheres to the liner 18 because there is no release coating between the liner 18 and the adhesive section 23. The release coating 14 associated with adhesive section 23 allows the label 50 to be removed from the laminate without adhesive section 23 adhering to the label 50. The reverse is true with adhesive section 22 as the section 16 of release coating has been applied to the liner, and not the face layer. The adhesive section 22 adheres to the label 50 and not the section 16 of release coating and the label 50 is produced having a section 14 of release coating and a section 22 of adhesive. The adhesive section 22 adheres to the shelf 40 and the section 14 of release coating hangs below the shelf 40 so that there is no adhesive to adhere to the underside of shelves, consumers, other products, etc.

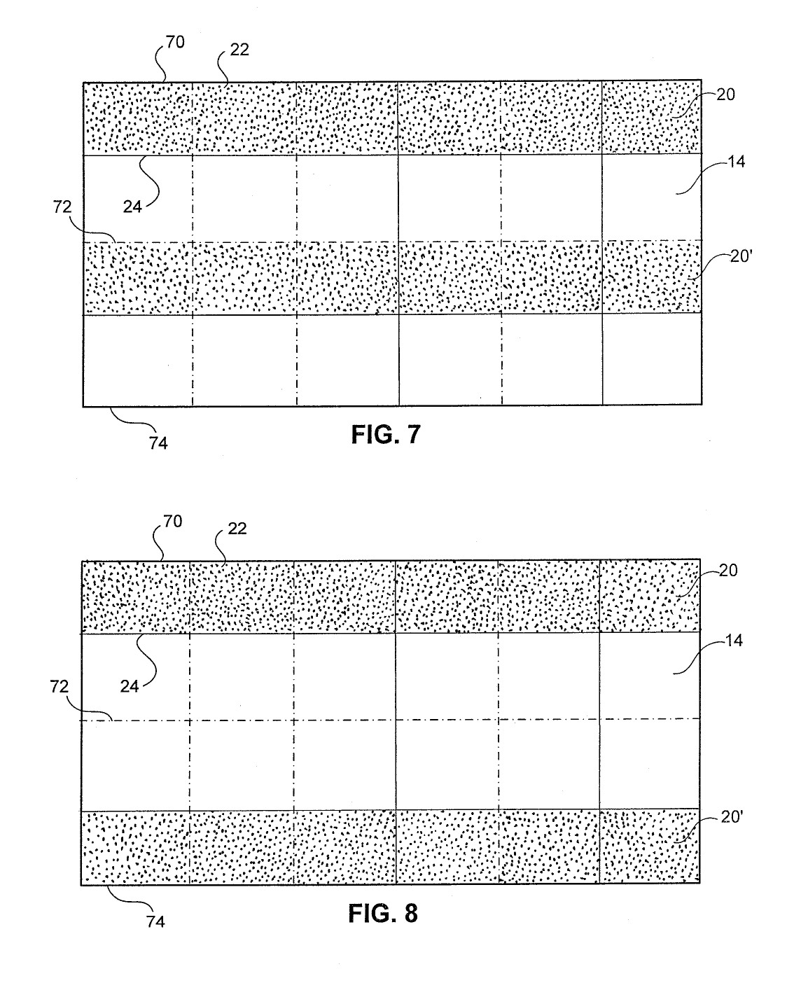

FIG. 7 shows an alternate layout for the label sheet where the labels are oriented vertically instead of horizontally. In FIG. 7, the adhesive 20 is adjacent to an upper edge 70 and a release coating is adjacent to a lower edge 72 of the label. As shown, there are multiple rows of labels. Thus, a middle adhesive layer 20′ can be applied adjacent to the lower edge 72 of the first row of labels and release coating can be applied adjacent to lower edge 74 of the second row of labels. Although not shown, additional rows or columns of labels are contemplated.

Another aspect of a multiple row label sheet is shown in FIG. 8. Here, adhesive layer 20 is adjacent to edge 70 and adhesive layer 20′ is adjacent to edge 74. Release coating is applied between adhesive layers 20, 20′. Edge 72 is formed by cutting through the face layer such that individual labels are formed. The cut may further extend through the release coating(s). Vertical cuts are further made to form these individual labels. In one aspect, the cuts terminate at the liner layer. In other aspects, cuts extend through the adhesive layer. It is understood that the opposite configuration of adhesive and release coating may remain on the liner due to the location of adhesive relative to the release coating as has been previously discussed.

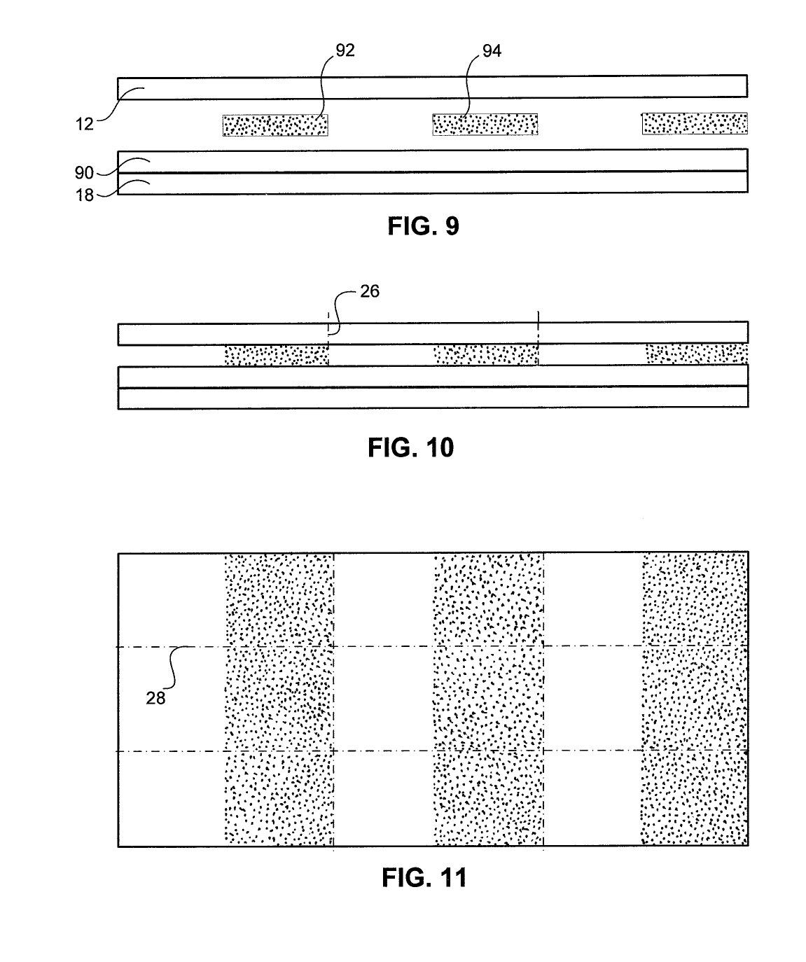

It is also contemplated that in an alternative embodiment that the selective application of release coating may be eliminated and adhesive is selectively applied in layers 20, 20′ as shown and described in FIGS. 9-11. In this case, the release coating may be applied throughout the surface of the liner.

In some cases, the selective application of adhesive would be advantageous to pre-printed labels. In one embodiment, the graphics 10 could be applied to the face layer prior to the cutting into individual labels. For example, the face layer could be printed first or the laminate could be formed and the face layer could be printed after the laminate has been formed. Typically, cutting would need to take place after printing, because the cutting would cause the non-adhesive portions of the labels to hang from the laminate such that the labels and thus the adhesive could become caught in the printing press. However, it is contemplated that some printing presses could be configured to print label sheets according to FIGS. 9-11 after the cuts 26/28 have already been formed in the labels.

It may be advantageous that the adhesive be selectively applied to the face layer by only applying adhesive to sections of the face layer where needed. For example, FIG. 9-11 show a face layer 12 and a liner 18 having a release coating 90 thereon. As has been previously discussed, the release coating may be a silicone based coating or other coating that releases from the adhesive. Sections of adhesive 92/94 are applied between face layer 12 and the release coating 90. Thus, the adhesive sections 92/94 will adhere to the face layer 12 and not the liner 18 or release coating 90. The face layer is cut along cut line 26/28 to create multiple labels within the laminate.

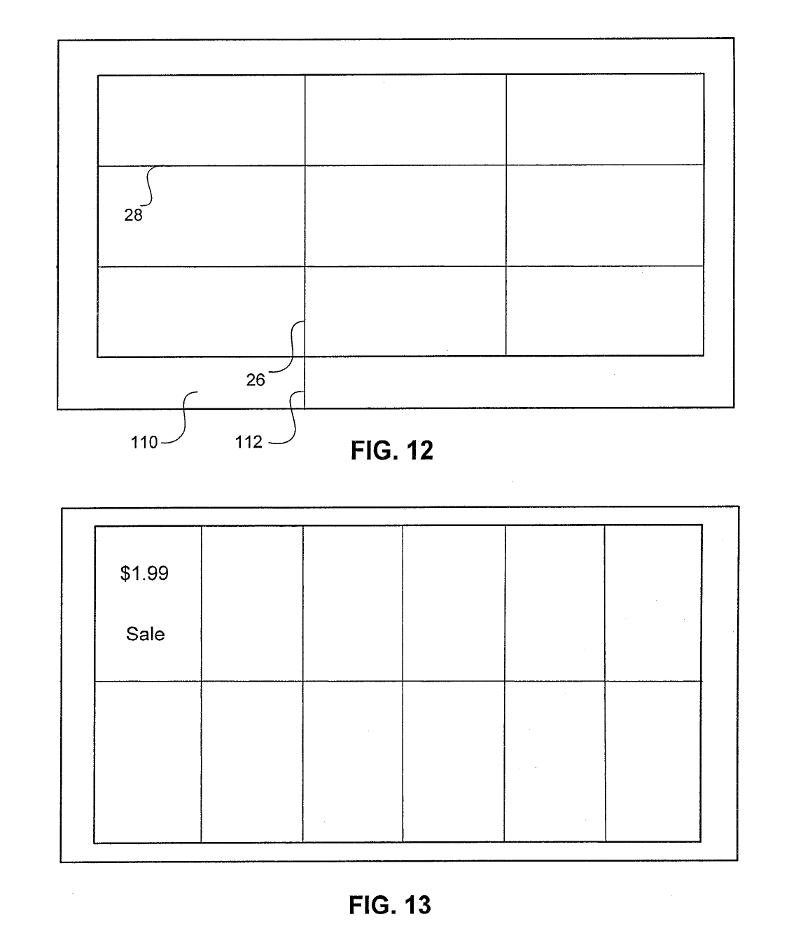

FIGS. 12 and 13 show horizontal (FIG. 12) and vertical (FIG. 13) configurations of a label sheet as has been described previously. The peripheral area 110 surrounding the labels may include a cut 112, which may be an extension of cut 26 therein. Thus, the surrounding area of the liner may be removed to allow labels to more easily be separated from the liner. In this case, it is further contemplated that release coating may be applied to the liner below this peripheral area so that pulling the face layer away from the liner around this section would cause the adhesive to adhere to the face layer. The cuts may also extend into the liner to ensure that the cuts define the perimeter of the label and that the label may be removed easily. In most cases, the cuts would not extend all the way through the liner.

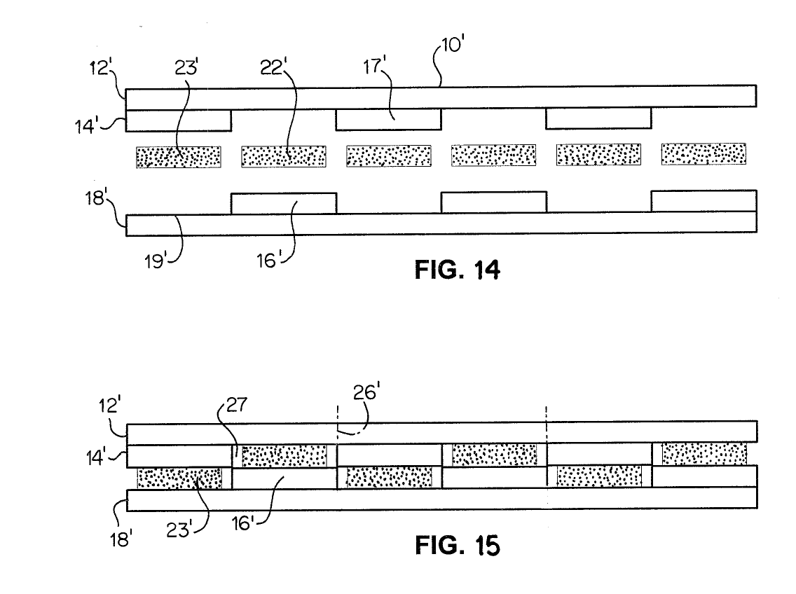

In FIGS. 14 and 15, the laminate is shown with adhesive sections 22′/23′ being narrower than the release coating sections 14′/16′/17′ such that a void 27 is formed between adhesive and release sections when the laminate is assembled. As shown in FIG. 15, the cut line 26′ extends through the face layer 12′ and into the void 27. In some cases this may allow the labels to be more easily removed from the sheet. In other cases, the void 27 could allow the cutting device that creates the cut lines 27 to be kept free of adhesive.

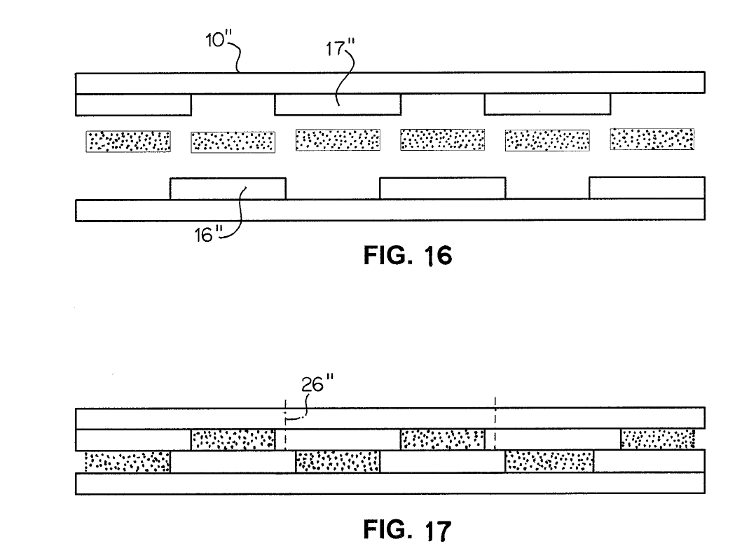

FIGS. 16 and 17 show an example where the release sections 16″ and 17″ overlap when the laminate is assembled. The cut line 26″ extends through the face layer but may also extend through the upper or upper and lower release coatings. In some aspects, cut lines 26/26′ and/or 26″ may extend all the way through the liner layer. In this aspect, the liner layer may be of a similar material to the face layer or another material that can receive printed indicia thereon. For example a vinyl material. In this aspect, the liner and face layers may be pre-printed with the appropriate indicia prior to cutting and thus pairs of labels are created by the cut lines that extend all the way through the laminate. This allows for less wasted material in that both the bottom and top sections of the laminate may be used for shelf marking purposes.

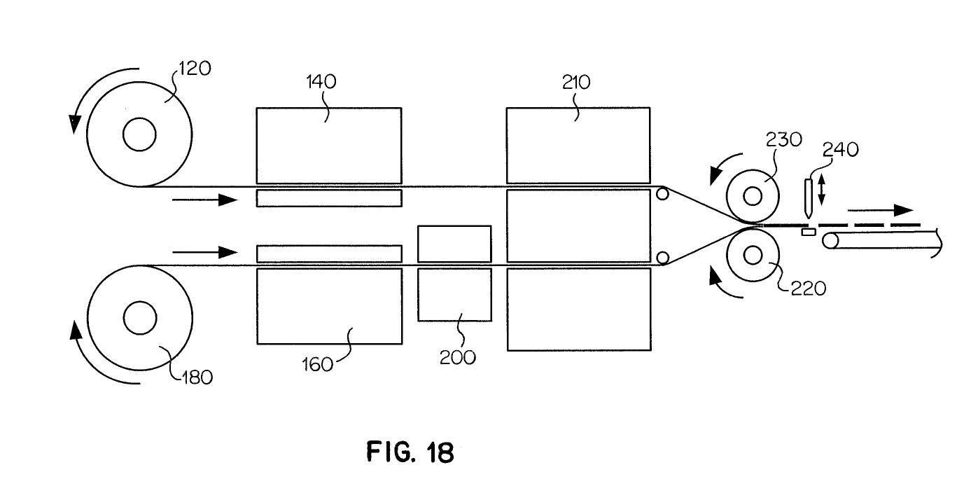

FIG. 18 is a schematic representation of an exemplary process of making the laminate and labels described. Material feeds 120/180 include rolls of the face 180 and liner layers 120. It is understood that the orientation of the face 180 and liner layers 120 may be switched such that the liner layer passes through the adhesive applicator 200. In some embodiments, the liner 120 is made of a printable material, which may be the same as the face layer 180. Release coating applicators 140/160 apply the strips of release coating to the face and liner layers as is shown in FIGS. 1-17. Adhesive applicator 200 applies adhesive and/or sections/strips of adhesive as shown and described herein. The layers 120/180 now having adhesive and release coatings applied as appropriate pass through a dryer 210. Laminators 230/220 join layers 120/180 to form a laminate and cutter 240 creates the appropriate cut lines that are shown and described herein. It is understood that a printer may be positioned between the laminators 230/220 and the cutter 240 such that the laminate may be pre-printed before cutting. It is also contemplated that the process can use separate machines for the laminating and the printing/cutting processes. Although not shown, a second adhesive applicator may be positioned such that layer 120 passes therethrough. In addition, it is understood that depending on the processing and application requirements of the particular adhesive and/or release coating used, additional dryers may be positioned between the release applicators 140/160 and the adhesive applicator 200. It is also contemplated that the dryer 210 can be positioned between the release applicators 140/160 and the adhesive applicator 200.

Various types of adhesives can be used, for example, a pressure sensitive adhesive, acrylic adhesive and various types of adhesives that allow the label to be placed, removed and re-positioned without leaving adhesive residue on the shelf.

Although the invention has been described with reference to a particular arrangement of parts, features and the like, these are not intended to exhaust all possible arrangements or features, and indeed many other modifications and variations will be ascertainable to those of skill in the art.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

What is claimed is:

1. A laminate comprising:
a face layer;
a liner layer;
an adhesive disposed between said face and liner layers;
a first section of release coating applied to said face layer between said face layer and said adhesive and having a first width;
a second section of release coating applied to said liner layer parallel to said first section and disposed between said liner layer and said adhesive, said second section of release coating having a second width;
a cut line extending into said face layer along an edge of said first section of release coating.

2. The laminate of claim 1 wherein at least part of said first and second sections of release coating extend along opposite sides of said cut line.

3. The laminate of claim 2 wherein a common plane is defined by an edge of said first section of release coating and an edge of said second section of release coating and the cut line extends along the common plane.

4. The laminate of claim 1 wherein said cut line includes a pair of cut lines spaced apart at a distance such that said first and second sections of release coating are located between the pair of cut lines.

5. The laminate of claim 4 wherein said adhesive includes a plurality of adhesive sections and further comprising:
a width of at least one of the plurality of adhesive sections is less than one of the first or second widths to define a void between said face and liner layers;
said cut line extending through said face layer at the void.

6. The laminate of claim 1 wherein said adhesive includes a plurality of adhesive sections and further comprising:
a first one of the plurality of adhesive sections disposed parallel to said first section of release coating and disposed between said second section of release coating and said face layer;
a second one of the plurality of adhesive sections disposed parallel to said second section of release coating and disposed between said first section of release coating and said liner layer.

7. The laminate of claim 6 wherein said adhesive includes a plurality of adhesive sections and further comprising:
a width of at least one of the plurality of adhesive sections is less than one of the first or second widths to define a void between said face and liner layers.

8. The laminate of claim 7 wherein said cut line extends into said face layer at the void.

9. The laminate of claim 1 wherein said cut line includes a pair of cut lines spaced apart at a distance such that said first and second sections of release coating are located between the pair of cut lines and further comprising:
two cut lines spaced apart and extending between the pair of cut lines such that said two cut lines and said pair of cut lines define a perimeter of a label.

10. A laminate comprising:
a face layer;
a liner layer;
a plurality of release coating sections applied to the liner and the face layer such that at least two of said plurality of release coating sections are located on the face layer;
the at least two of said plurality of release coating sections spaced apart at a distance from each other to define a gap;
another one of said plurality of release coating sections aligned with the gap;
a section of adhesive aligned with the gap and disposed between said face layer and said at least one of said plurality of release coating sections; and
a pair of cut lines extending into the face layer and spaced apart at a distance such said section of adhesive and one of said plurality of release coating sections applied to the face layer are disposed between said pair of cut lines.

11. The laminate of claim 10 further comprising:
a width of said section of adhesive is less than a width of said gap;
a void formed between adhesive and release sections;
said cut line extending through said face layer at said void.

12. The laminate of claim 10 further comprising:
one of said at least two of said plurality of release coating sections and said another one of said plurality of release coating sections each have an edge defining a plane, said one of said at least two of said plurality of release coating sections and said another one of said plurality of release coating sections extend in opposite directions from the plane.

13. The laminate of claim 10 further comprising:
two cut lines disposed at an angle relative to said pair of cut lines wherein said pair of cut lines intersect with the two cut lines to define a perimeter of a label.

14. The laminate of claim 10 further comprising printed indicia on an outer surface of said face layer.

15. The laminate of claim 10 wherein said adhesive is a pressure sensitive adhesive.

16. The laminate of claim 10 wherein said release coating comprises silicone.

17. A method of manufacturing a laminate comprising the steps:
providing a face layer;
providing a liner layer;
applying a plurality of strips of release coating to said face and liner layers;
applying a plurality of strips of adhesive to said face and liner layers;
laminating said face and liner layers such that at least one adhesive strip of said face layer aligns with at least one of said plurality of strips of release coating applied to said liner layer; and
cutting said face layer to define a pair of cut lines spaced apart such that said section of adhesive and one of said plurality of release coating sections applied to the face layer are disposed between said pair of cut lines.

18. The method of claim 17 wherein each one of the strips of adhesive of said face layer aligns with one of the strips of release coating.

19. The method of claim 18 wherein a width of the strips of adhesive of the face layer is less than a width of the aligned strip of release coating of the liner layer such that a void is formed between the strips of adhesive of the face layer and the strips of release coating of the face layer.

20. The method of claim 19 wherein:
said step of applying a plurality of release coatings defines at least one adhesive receiving section between two of said plurality of strips of release coating, at least one of the plurality of strips of adhesive applied to the at least one adhesive receiving section;
said cutting step further comprises cutting through the face layer at an angle relative to the pair of cut lines to define two of cut lines, the two cut lines extending between the pair of cut lines such that the pair of cut lines and the two cut lines define a perimeter of a label.

21. The method of claim 20 wherein upon removal of said label from said liner a portion of adhesive and a portion of release coating is located on the rear surface of the label.

22. The method of claim 17 further comprising:
cutting said face layer to define a label such that when the label is removed from said liner layer, a section of adhesive is adjacent to a first edge of the label and a section of release coating is adjacent to an opposite edge of the label.

23. The method of claim 22 wherein said cutting step defines a cut extending through said face layer and terminating at said liner layer.
